(19) United States
(12) Patent Application Publication
(10) Pub. No.: US 2026/0188841 A1
(43) Pub. Date: Jul. 2, 2026

(54) INGREDIENT FOR SECONDARY CELL SEPARATOR COATING MATERIAL, SECONDARY CELL SEPARATOR COATING MATERIAL, SECONDARY CELL SEPARATOR, AND SECONDARY CELL

(71) Applicant: MITSUI CHEMICALS, INC., Chuo-ku, Tokyo (JP)

(72) Inventors: Yoshihiko TOMITA, Ichihara-shi, Chiba (JP); Tsuyoshi YAMAGUCHI, Ichihara-shi, Chiba (JP); Yasuyuki KAGAWA, Ichihara-shi, Chiba (JP)

(73) Assignee: MITSUI CHEMICALS, INC., Chuo-ku, Tokyo (JP)

(21) Appl. No.: 19/129,529

(22) PCT Filed: Nov. 22, 2023
(86) PCT No.: PCT/JP2023/041987

§ 371 Date: May 13, 2025

(30) Foreign Application Priority Data
Nov. 29, 2022 (JP) 2022-190700

(51) Int. Cl. H01M 50/42; H01M 10/0525; H01M 50/443; H01M 50/446; H01M 50/449

(52) U.S. Cl. CPC H01M 50/42; H01M 10/0525; H01M 50/443; H01M 50/446; H01M 50/449

(57) ABSTRACT

An ingredient for a secondary cell separator coating material includes a water-soluble acrylic resin and polyvinyl alcohol. A saponification degree of the polyvinyl alcohol is 85 mol % or more.

### TECHNICAL FIELD

The present invention relates to an ingredient for a secondary cell separator coating material, a secondary cell separator coating material, a secondary cell separator, and a secondary cell, to be specific, to an ingredient for a secondary cell separator coating material, a secondary cell separator coating material including the ingredient for a secondary cell separator coating material, a secondary cell separator including a coating film of the secondary cell separator coating material, and a secondary cell including the secondary cell separator.

### BACKGROUND ART

Conventionally, a secondary cell is equipped with a separator for separating a positive electrode from a negative electrode, and allowing ions in an electrolytic solution to pass through.

As such a separator, for example, a polyolefin porous film has been known.

On the other hand, a coating layer may be provided on the surface of the separator in order to impart various properties. Such a coating layer is formed, for example, by coating a secondary cell separator coating material onto the surface of the separator and drying the coating material.

As such a secondary cell separator coating material, for example, a secondary cell separator coating material containing an ingredient for a secondary cell separator coating material containing a water-soluble polymer obtained by polymerizing a water-soluble polymer raw material containing methacrylamide and methacrylic acid, and an inorganic filler has been proposed (ref for example, Patent Document 1).

### CITATION LIST

### Patent Document

Patent Document 1: Japanese Unexamined Patent Publication No. 2021-103676

### SUMMARY OF THE INVENTION

### Problem to be Solved by the Invention

On the other hand, when the separator changes its shape due to shrinkage by heat, a short circuit may occur between the positive electrode and the negative electrode. Therefore, heat resistance is required for the coating layer.

Further, the coating layer requires adhesion to the separator.

The present invention provides an ingredient for a secondary cell separator coating material having excellent heat resistance and excellent adhesion, a secondary cell separator coating material including the ingredient for a secondary cell separator coating material, a secondary cell separator including a coating film of the secondary cell separator coating material, and a secondary cell including the secondary cell separator.

### Means for Solving the Problem

The present invention [1] includes an ingredient for a secondary cell separator coating material including a water-soluble acrylic resin and polyvinyl alcohol, wherein a saponification degree of the polyvinyl alcohol is 85 mol % or more.

The present invention [2] includes the ingredient for a secondary cell separator coating material described in the above-described [1], wherein a content ratio of the polyvinyl alcohol is 5 parts by mass or more and 50 parts by mass or less with respect to 100 parts by mass of the water-soluble acrylic resin.

The present invention [3] includes the ingredient for a secondary cell separator coating material described in the above-described [1], wherein the polyvinyl alcohol is at least one selected from the group consisting of unmodified polyvinyl alcohol and anionic group-modified polyvinyl alcohol.

The present invention [4] includes the ingredient for a secondary cell separator coating material described in the above-described [1], wherein a weight average molecular weight of the water-soluble acrylic resin is 10000 or more and 150000 or less.

The present invention [5] includes a secondary cell separator coating material including the ingredient for a secondary cell separator coating material described in any one of the above-described [1] to [4] and inorganic particles.

The present invention [6] includes a secondary cell separator including a porous film and a coating film of the secondary cell separator coating material described in the above-described [5] disposed on at least one surface of the porous film.

The present invention [7] includes a secondary cell including a positive electrode, a negative electrode, and the secondary cell separator described in the above-described [6] disposed between the positive electrode and the negative electrode.

### Effect of the Invention

The ingredient for a secondary cell separator coating material of the present invention includes the water-soluble acrylic resin, and the polyvinyl alcohol having the saponification degree of a predetermined value or more. Therefore, heat resistance and adhesion are excellent.

The secondary cell separator coating material of the present invention includes the ingredient for a secondary cell separator coating material of the present invention. Therefore, the heat resistance and the adhesion are excellent.

The secondary cell separator of the present invention includes the coating film of the secondary cell separator coating material of the present invention. Therefore, the heat resistance and the adhesion are excellent.

The secondary cell of the present invention includes the secondary cell separator of the present invention. Therefore, the heat resistance and the adhesion are excellent.

### DESCRIPTION OF EMBODIMENTS

An ingredient for a secondary cell separator coating material includes a water-soluble acrylic resin and polyvinyl alcohol.

### <Water-Soluble Acrylic Resin>

The water-soluble acrylic resin is a polymer obtained by polymerizing a water-soluble acrylic resin raw material.

The water-soluble acrylic resin is defined as an acrylic resin having a residual solid content of 0.1% or less when 1 g of water-soluble acrylic resin once dried is dissolved and stirred in 100 ml of water for 24 hours, and thereafter, filtered through a 300-mesh wire mesh.

The water-soluble acrylic resin raw material includes, for example, (meth)acrylamide and a carboxy group-containing vinyl monomer.

### {(Meth)Acrylamide}

(Meth)acrylamide shows methacrylamide and/or acrylamide. As the (meth)acrylamide, from the viewpoint of ion permeability, preferably, methacrylamide is used.

A content ratio of the (meth)acrylamide is, for example, 60 parts by mass or more, preferably 75 parts by mass or more, and for example, 98 parts by mass or less, preferably 90 parts by mass or less, more preferably 85 parts by mass or less with respect to 100 parts by mass of the total amount of the water-soluble acrylic resin raw material.

### {Carboxy Group-Containing Vinyl Monomer}

The carboxy group-containing vinyl monomer is a vinyl monomer which is copolymerizable with the (meth)acrylamide and contains a carboxy group.

Examples of the carboxy group-containing vinyl monomer include monocarboxylic acid, dicarboxylic acid, or a salt of these. An example of the monocarboxylic acid includes (meth)acrylic acid. Examples of the dicarboxylic acid include itaconic acid, maleic acid, fumaric acid, itaconic anhydride, maleic anhydride, and fumaric anhydride.

As the carboxy group-containing vinyl monomer, preferably, monocarboxylic acid is used, more preferably, (meth)acrylic acid is used, further more preferably, methacrylic acid is used.

These carboxy group-containing vinyl monomers may be used alone or in combination of two or more.

The content ratio of the carboxy group-containing vinyl monomer is, for example, 1 part by mass or more, preferably 3 parts by mass or more, and for example, 35 parts by mass or less, preferably 20 parts by mass or less, more preferably 10 parts by mass or less, further more preferably 7 parts by mass or less with respect to 100 parts by mass of the total amount of the water-soluble acrylic resin raw material.

### {Copolymerizable Monomer}

The water-soluble acrylic resin raw material may contain a copolymerizable monomer which is copolymerizable with the (meth)acrylamide and the carboxy group-containing vinyl monomer.

Examples of the copolymerizable monomer include alkyl (meth)acrylate, functional group-containing vinyl monomers (excluding the carboxy group-containing vinyl monomers), vinyl esters, aromatic vinyl monomers, N-substituted unsaturated carboxylic acid amides, heterocyclic vinyl compounds, vinylidene halide compounds, α-olefins, dienes, and cross-linking vinyl monomers.

Examples of the alkyl (meth)acrylate include alkyl (meth)acrylates having an alkyl moiety having 1 to 12 carbon atoms. Examples of the alkyl (meth)acrylate having an alkyl moiety having 1 to 12 carbon atoms include alkyl (meth)acrylates having an alkyl moiety having 1 to 4 carbon atoms and alkyl (meth)acrylates having an alkyl moiety having 5 to 12 carbon atoms. Examples of the alkyl (meth)acrylate having an alkyl moiety having 1 to 4 carbon atoms include methyl (meth)acrylate, ethyl (meth)acrylate, isopropyl (meth)acrylate, n-butyl (meth)acrylate, isobutyl (meth)acrylate, and t-butyl (meth)acrylate. Examples of the alkyl (meth)acrylate having an alkyl moiety having 5 to 12 carbon atoms include n-amyl (meth)acrylate, isoamyl (meth)acrylate, n-hexyl (meth)acrylate, 2-ethylhexyl (meth)acrylate, octyl (meth)acrylate, decyl (meth)acrylate, dodecyl (meth)acrylate, and octadecyl (meth)acrylate.

Examples of the functional group-containing vinyl monomer (excluding the carboxy group-containing vinyl monomer) include sulfonic acid group-containing vinyl monomers, phosphoric acid group-containing vinyl monomers, hydroxyl group-containing vinyl monomers, amino group-containing vinyl monomers, glycidyl group-containing vinyl monomers, cyano group-containing vinyl monomers, and acetoacetoxy group-containing vinyl monomers.

Examples of the sulfonic acid group-containing vinyl monomer include allylsulfonate, methallylsulfonate, and acrylamide t-butylsulfonate. Further, examples of the sulfonic acid group-containing vinyl monomer include salts thereof. Examples of the salt of the sulfonic acid group-containing vinyl monomer include alkali metal salts (for example, sodium salt and potassium salt) and ammonium salts. Specific examples thereof include sodium allylsulfonate, sodium methallylsulfonate, and ammonium methallylsulfonate.

An example of the phosphoric acid group-containing vinyl monomer includes 2-methacryloyloxyethyl acid phosphate.

Examples of the hydroxyl group-containing vinyl monomer include 2-hydroxyethyl (meth)acrylate and 2-hydroxypropyl (meth)acrylate. As the hydroxyl group-containing vinyl monomer, preferably, 2-hydroxylethyl (meth)acrylate is used. As the hydroxyl group-containing vinyl monomer, more preferably, 2-hydroxyethyl methacrylate is used.

Examples of the amino group-containing vinyl monomer include 2-aminoethyl (meth)acrylate, 2-(N-methylamino)ethyl (meth)acrylate, and 2-(N,N-dimethylamino)ethyl (meth)acrylate.

An example of the glycidyl group-containing vinyl monomer includes glycidyl (meth)acrylate.

An example of the cyano group-containing vinyl monomer includes (meth)acrylonitrile. As the cyano group-containing vinyl monomer, preferably, acrylonitrile is used.

An example of the acetoacetoxy group-containing vinyl monomer includes acetoacetoxyethyl (meth)acrylate.

Examples of the vinyl esters include vinyl acetate and vinyl propionate.

Examples of the aromatic vinyl monomer include styrene, α-methylstyrene, p-methylstyrene, vinyltoluene, and chlorostyrene.

An example of the N-substituted unsaturated carboxylic acid amide includes N-methylol (meth)acrylamide.

An example of the heterocyclic vinyl compound includes vinylpyrrolidone.

Examples of the vinylidene halide compound include vinylidene chloride and vinylidene fluoride.

Examples of the α-olefins include ethylene and propylene.

An example of the dienes includes butadiene.

Examples of the cross-linking vinyl monomer include vinyl monomers having two or more vinyl groups. Examples of the vinyl monomer having two or more vinyl groups include methylenebis(meth)acrylamide, divinylbenzene, polyethylene glycol chain-containing di(meth)acrylate, trimethylolpropane tetraacrylate, pentaerythritol triacrylate, and pentaerythritol tetraacrylate.

As the copolymerizable monomer, preferably, a functional group-containing vinyl monomer is used. As the copolymerizable monomer, more preferably, a hydroxyl group-containing vinyl monomer is used.

These copolymerizable monomers may be used alone or in combination of two or more.

The content ratio of the copolymerizable monomer is, for example, 3 parts by mass or more, preferably 5 parts by mass or more, more preferably 12 parts by mass or more, and for example, 30 parts by mass or less, preferably 20 parts by mass or less with respect to 100 parts by mass of the total amount of the water-soluble acrylic resin raw material.

The water-soluble acrylic resin raw material is polymerized by a known method, thereby obtaining the water-soluble acrylic resin.

Specifically, for example, the water-soluble acrylic resin raw material and a polymerization initiator are blended into water, the water-soluble acrylic resin raw material is polymerized, and thereafter, if necessary, the polymerized product is aged.

The polymerization initiator is not particularly limited, and examples thereof include water-soluble initiators, oil-soluble initiators, and redox-based initiators. Examples of the water-soluble initiator include persulfate (for example, ammonium persulfate, potassium persulfate), hydrogen peroxide, organic hydroperoxide, and 4,4′-azobis(4-cyanovaleric acid) acid. Examples of the oil-soluble initiator include benzoyl peroxide and azobisisobutyronitrile.

As the polymerization initiator, preferably, a water-soluble initiator is used, more preferably, persulfate is used, further more preferably, ammonium persulfate is used.

A mixing ratio of the polymerization initiator is, for example, 0.01 parts by mass or more, preferably 0.1 parts by mass or more, more preferably 0.2 parts by mass or more, further more preferably 0.5 parts by mass or more, and for example, 3 parts by mass or less, preferably 1 part by mass or less with respect to 100 parts by mass of the water-soluble acrylic resin raw material.

These polymerization initiators may be used alone or in combination of two or more.

A polymerization temperature is, for example, 30° C. or more, preferably 50° C. or more, and for example, 95° C. or less, preferably 85° C. or less under a normal pressure. Further, polymerization time is, for example, 0.5 hours or more, preferably 1.5 hours or more, and for example, 20 hours or less, preferably 10 hours or less.

Aging time is, for example, 0.5 hours or more, preferably 1.5 hours or more, and for example, 6 hours or less, preferably 4 hours or less.

In addition, in the above-described polymerization, from the viewpoint of improving production stability, for example, a known additive may be blended at an appropriate ratio. Examples of the known additive include pH adjusting agents, metal ion sealing agents (for example, ethylenediaminetetraacetic acid and a salt thereof), and molecular weight adjusting agents (chain transfer agents) (for example, mercaptans and low molecular halogen compounds).

Further, before or after the above-described polymerization, a neutralizing agent such as ammonia may be blended, and a pH may be also adjusted within a range of 6 or more and 11 or less.

Thus, the water-soluble acrylic resin (aqueous solution containing the water-soluble acrylic resin) is obtained as the polymer of the water-soluble acrylic resin raw material.

In the aqueous solution containing the water-soluble acrylic resin, the solid content concentration of the water-soluble acrylic resin is, for example, 10% by mass or more, and for example, 50% by mass or less.

A weight average molecular weight of the water-soluble acrylic resin is, from the viewpoint of improving the ion permeability, for example, 10000 or more, preferably 50000 or more, more preferably 68000 or more, and for example, 500000 or less, preferably 200000 or less, from the viewpoint of improving the ion permeability, more preferably 150000 or less, further more preferably 100000 or less, particularly preferably 80000 or less.

A method for measuring the above-described weight average molecular weight is described in detail in Examples to be described later.

In addition, a glass transition temperature (Tg) of the water-soluble acrylic resin is, for example, 100° C. or more, preferably 150° C. or more, more preferably 210° C. or more, further more preferably 220° C. or more, and for example, 270° C. or less, preferably 250° C. or less, more preferably 225° C. or less.

The above-described glass transition temperature (Tg) can be calculated by a formula of FOX.

The content ratio of the water-soluble acrylic resin is, for example, 60 parts by mass or more, preferably 70 parts by mass or more, more preferably 80 parts by mass or more, and for example, 98 parts by mass or less, preferably 90 parts by mass or less with respect to 100 parts by mass of the total amount of the water-soluble acrylic resin and the polyvinyl alcohol.

### <Polyvinyl Alcohol>

The polyvinyl alcohol is a component for imparting wettability and improving adhesion to the ingredient for a secondary cell separator coating material.

The polyvinyl alcohol has a saponification degree of a predetermined value or more.

Specifically, the saponification degree of the polyvinyl alcohol is 85 mol % or more, preferably 90 mol % or more, more preferably 95 mol % or more, particularly preferably 98 mol % or more, and for example, 100 mol % or less, preferably 99 mol % or less.

When the saponification degree of the polyvinyl alcohol is the above-described lower limit or more, heat resistance and the adhesion are improved.

On the other hand, when the saponification degree of the polyvinyl alcohol is below the above-described lower limit, the heat resistance and the adhesion are lowered.

Examples of the polyvinyl alcohol include unmodified polyvinyl alcohol and modified polyvinyl alcohol.

Examples of the modified polyvinyl alcohol include anionic group-modified polyvinyl alcohol (for example, carboxyl group-modified polyvinyl alcohol, sulfo group-modified polyvinyl alcohol), and hydrophobic group-modified polyvinyl alcohol.

As the polyvinyl alcohol, preferably, from the viewpoint of improving the ion permeability, at least one selected from the group consisting of unmodified polyvinyl alcohol and anionic group-modified polyvinyl alcohol is selected.

The polyvinyl alcohol may be used alone or in combination of two or more.

The content ratio of the polyvinyl alcohol is, for example, from the viewpoint of coatability, 5 parts by mass or more, preferably 10 parts by mass or more, and for example, 90 parts by mass or less, preferably, from the viewpoint of the ion permeability, 50 parts by mass or less, more preferably 30 parts by mass or less, further more preferably 20 parts by mass or less with respect to 100 parts by mass of the water-soluble acrylic resin.

In addition, the content ratio of the polyvinyl alcohol is, for example, 2 parts by mass or more, preferably, from the viewpoint of improving the coatability, 10 parts by mass or more, and for example, 60 parts by mass or less, preferably, from the viewpoint of improving the ion permeability, 40 parts by mass or less, more preferably 30 parts by mass or less, further more preferably 20 parts by mass or less with respect to 100 parts by mass of the total amount of the water-soluble acrylic resin and the polyvinyl alcohol.

Further, when the content ratio of the polyvinyl alcohol is within the above-described range, the wettability is excellent. Thus, among others, a coating film having the excellent heat resistance and the excellent adhesion can be formed on the surface of a porous film without a surface treatment (for example, corona discharge treatment, described later).

Further, the polyvinyl alcohol may be also prepared as the aqueous solution of the polyvinyl alcohol. In the aqueous solution of the polyvinyl alcohol, the solid content concentration of the polyvinyl alcohol is, for example, 5% by mass or more, and for example, 50% by mass or less.

In addition, the ingredient for a secondary cell separator coating material may also include the polyvinyl alcohol having the saponification degree of below the above-described predetermined value (hereinafter, another polyvinyl alcohol) together with the polyvinyl alcohol having the saponification degree of the above-described predetermined value or more.

The content ratio of another polyvinyl alcohol is, for example, 10% by mass or less, preferably 5% by mass or less, more preferably 1% by mass or less with respect to the ingredient for a secondary cell separator coating material (solid content).

The ingredient for a secondary cell separator coating material preferably does not contain another polyvinyl alcohol.

### <Preparation of Ingredient for Secondary Cell Separator Coating Material>

The ingredient for a secondary cell separator coating material is prepared by mixing the water-soluble acrylic resin (aqueous solution containing the water-soluble acrylic resin) and the polyvinyl alcohol.

In addition, the additive may be blended into the ingredient for a secondary cell separator coating material at the appropriate ratio, if necessary. Examples of the additive include wetting agents, dispersants, hydrophilic resins, wetting agents, defoaming agents, and pH adjusting agents. In other words, the ingredient for a secondary cell separator coating material contains the additive, if necessary.

On the other hand, since the ingredient for a secondary cell separator coating material contains the water-soluble acrylic resin and the polyvinyl alcohol, it has the excellent wettability. Therefore, the ingredient for a secondary cell separator coating material has the excellent wettability, even when it does not contain the wetting agent. In other words, the ingredient for a secondary cell separator coating material preferably contains the water-soluble acrylic resin and the polyvinyl alcohol, and does not contain the wetting agent.

Since the ingredient for a secondary cell separator coating material contains the water-soluble acrylic resin and the polyvinyl alcohol, it has the excellent heat resistance and the excellent adhesion.

Then, the ingredient for a secondary cell separator coating material, among others, can be preferably used as an ingredient for a secondary cell separator coating material.

In the following, a secondary cell separator coating material obtained by using the ingredient for a secondary cell separator coating material is described in detail.

### <Secondary Cell Separator Coating Material>

The secondary cell separator coating material includes the above-described ingredient for a secondary cell separator coating material and inorganic particles.

Examples of the inorganic particles include oxides, nitrides, carbides, sulfates, hydroxides, and potassium titanate. Examples of the oxide include alumina, silica, titania, zirconia, magnesia, ceria, yttria, zinc oxide, and iron oxide. Examples of the nitride include silicon nitride, titanium nitride, and boron nitride. Examples of the carbide include silicon carbide and calcium carbonate. Examples of the sulfate include magnesium sulfate and aluminum sulfate. Examples of the hydroxide include aluminum hydroxide and aluminum hydroxide oxide. Examples of the silicate include talc, kaolinite, dickite, nacrite, halloysite, pyrophyllite, montmorillonite, sericite, mica, amesite, bentonite, asbestos, zeolite, calcium silicate, magnesium silicate, diatomaceous earth, silica sand, and glass.

As the inorganic particles, preferably, a hydroxide is used. As the inorganic particles, more preferably, an aluminum hydroxide oxide is used.

An average median diameter D50 of the inorganic particles is, for example, 0.1 μm or more, preferably 0.5 μm or more, and for example, 5 μm or less, preferably 1 μm or less.

These inorganic particles may be used alone or in combination of two or more.

The mixing ratio of the inorganic particles is described later.

Then, in order to produce the secondary cell separator coating material, first, the inorganic particles and, if necessary, a dispersant are blended into the water, thereby preparing an aqueous dispersion liquid of the inorganic particles. When the dispersant is blended, the secondary cell separator coating material includes the dispersant.

Examples of the dispersant include ammonium polycarboxylate and sodium polycarboxylate. As the dispersant, preferably, an ammonium polycarboxylate is used.

The mixing ratio of the dispersant (solid content) is, for example, 0.1 parts by mass or more, preferably 0.5 parts by mass or more, and for example, 10 parts by mass or less, preferably 3 parts by mass or less with respect to 100 parts by mass of the inorganic particles.

These dispersants may be used alone or in combination of two or more.

Next, the ingredient for a secondary cell separator coating material (aqueous dispersion liquid of the ingredient for a secondary cell separator coating material) is blended into the aqueous dispersion liquid of the inorganic particles to be stirred.

A stirring method is not particularly limited, and examples thereof include ball mills, bead mills, planetary ball mills, vibrating ball mills, sand mills, colloid mills, attritors, roll mills, high-speed impeller dispersion, stirrer, dispersers, homogenizers, high-speed impact mills, ultrasonic dispersion, and stirring blades.

In addition, if necessary, the above-described additive may be blended into the secondary cell separator coating material at the appropriate ratio. In other words, the secondary cell separator coating material includes, if necessary, the above-described additive. Also, the secondary cell separator coating material preferably does not include the wetting agent.

These additives may be used alone or in combination of two or more.

Thus, the secondary cell separator coating material is obtained. Further, such a secondary cell separator coating material is obtained as the aqueous dispersion liquid dispersed in the water.

The solid content concentration of the aqueous dispersion liquid of the secondary cell separator coating material is, for example, 10% by mass or more, preferably 20% by mass or more, more preferably 30% by mass or more, and for example, 50% by mass or less.

Also, in the secondary cell separator coating material (solid content), the content of the ingredient for a secondary cell separator coating material (solid content) is, for example, 3.0 parts by mass or more, preferably 4.2 parts by mass or more, and 10.0 parts by mass or less, preferably 7.0 parts by mass or less, more preferably 6.0 parts by mass or less with respect to 100 parts by mass of the total amount of the ingredient for a secondary cell separator coating material (solid content) and the inorganic particles. Further, the content of the inorganic particles is 90.0 parts by mass or more, preferably 93.0 parts by mass or more, more preferably 94.0 parts by mass or more, and for example, 97.0 parts by mass or less, preferably 95.8 parts by mass or less with respect to 100 parts by mass of the total amount of the ingredient for a secondary cell separator coating material (solid content) and the inorganic particles.

In addition, in the secondary cell separator coating material (solid content), the content of the ingredient for a secondary cell separator coating material (solid content) is, for example, 3.0 parts by mass or more, preferably 4.4 parts by mass or more, and for example, 10.0 parts by mass or less, preferably 7.0 parts by mass or less, more preferably 5.0 parts by mass or less with respect to 100 parts by mass of the total amount of the inorganic particles.

The secondary cell separator coating material includes the ingredient for a secondary cell separator coating material. Therefore, a secondary cell separator including the coating film obtained by using the secondary cell separator coating material has the excellent heat resistance and the excellent adhesion.

In the following, the secondary cell separator obtained by using the secondary cell separator coating material is described in detail.

### <Secondary Cell Separator>

The secondary cell separator includes the porous film and the coating film of the secondary cell separator coating material disposed on at least one surface of the porous film.

### [Porous Film]

Examples of the porous film include polyolefin porous films and aromatic polyamide porous films. Examples of the polyolefin porous film include polyethylene porous films and polypropylene porous films. As the porous film, preferably, a polyolefin porous film is used.

A thickness of the porous film is, for example, 1 μm or more, and for example, 40 μm or less, preferably 20 μm or less.

### [Coating Film]

The coating film imparts the heat resistance to the porous film. The coating film is made of the secondary cell separator coating material.

The thickness of the coating film is, for example, 1 μm or more, preferably 3 μm or more, and for example, 10 μm or less, preferably 8 μm or less.

### [Method for Producing Secondary Cell Separator]

A method for producing a secondary cell separator includes a first step of preparing the porous film and a second step of coating a separator coating material onto at least one surface of the porous film.

### (First Step)

In the first step, the porous film is prepared.

### (Second Step)

In the second step, the secondary cell separator coating material is coated onto at least one surface of the porous film, and thereafter, dried if necessary. Thus, the coating film is obtained.

In order to coat the secondary cell separator coating material onto at least one surface of the porous film, first, if necessary, one surface of the porous film is subjected to a surface treatment, and a surface treatment layer is formed on one surface of the porous film. That is, in such a case, the secondary cell separator includes the porous film, the surface treatment layer, and the coating film of the secondary cell separator coating material.

Examples of the surface treatment include corona discharge treatments, glow discharge treatments, plasma treatments, and ozone treatments. In this production method, preferably, from the viewpoint of improving the ion permeability, the surface treatment is not carried out. In other words, the secondary cell separator preferably does not include the surface treatment layer.

A method for coating the secondary cell separator coating material is not particularly limited, and examples thereof include wire bar methods, gravure coating methods, small diameter gravure coating methods, reverse roll coating methods, transfer roll coating method, kiss coating methods, dip coating methods, microgravure coating methods, knife coating methods, air doctor coating methods, blade coating methods, rod coating methods, squeeze coating methods, cast coating methods, die coating methods, screen printing methods, and spray coating methods. As the coating method, preferably, a wire bar method is used.

A drying temperature is, for example, 40° C. or more, and for example, 80° C. or less.

Thus, the secondary cell separator including the porous film, and the coating film of the above-described secondary cell separator coating material disposed on at least one surface of the porous film is produced.

In the above-described description, the coating film of the secondary cell separator coating material is disposed on at least one surface of the porous film. Alternatively, the above-described coating film can be also disposed on both surfaces of the porous film.

The secondary cell separator includes the coating film of the above-described secondary cell separator coating material. Therefore, the secondary cell separator has the excellent heat resistance and the excellent adhesion. Therefore, the secondary cell separator can be preferably used for the production of a secondary cell.

### <Secondary Cell>

The secondary cell includes a positive electrode, a negative electrode, the above-described secondary cell separator which is disposed between the positive electrode and the negative electrode, and an electrolyte which is impregnated into the positive electrode, the negative electrode, and the above-described secondary cell separator.

An example of the positive electrode includes a known electrode including a positive electrode collector and a positive electrode active material which is laminated on the positive electrode collector.

Examples of the positive electrode collector include electrically conductive materials such as aluminum, titanium, stainless steel, nickel, calcined carbon, electrically conductive polymers, and electrically conductive glass.

The positive electrode active material is not particularly limited, and examples thereof include known positive electrode active materials such as lithium-containing transition metal oxide, lithium-containing phosphate, and lithium-containing sulfate.

These positive electrode active materials may be used alone or in combination of two or more.

An example of the negative electrode includes a known electrode including a negative electrode collector and a negative electrode active material which is laminated on the negative electrode collector.

Examples of the negative electrode collector include electrically conductive materials such as copper and nickel.

The negative electrode active material is not particularly limited, and examples thereof include carbon active materials. Examples of the carbon active material include graphite, soft carbon, and hard carbon.

These negative electrode active materials may be used alone or in combination of two or more.

When a lithium ion cell is used as the secondary cell, an example of the electrolyte includes a solution in which a lithium salt is dissolved in a carbonate compound such as ethylene carbonate (EC), propylene carbonate (PC), and ethyl methyl carbonate (EMC).

Then, in order to produce the secondary cell, for example, the separator of the secondary cell is sandwiched between the positive electrode and the negative electrode to be housed in a cell casing (cell), and the electrolyte is poured into the cell casing. Thus, the secondary cell can be obtained.

The above-described secondary cell includes the above-described secondary cell separator. Therefore, the heat resistance and the adhesion are excellent.

### <Function and Effect>

The ingredient for a secondary cell separator coating material includes the water-soluble acrylic resin and the polyvinyl alcohol having the saponification degree of the above-described predetermined value or more. Therefore, the heat resistance and the adhesion are excellent.

Specifically, when the saponification degree of the polyvinyl alcohol is low, the wettability tends to decrease. Then, it is impossible to form the uniform coating film, and the heat resistance and the adhesion are lowered.

On the other hand, in the ingredient for a secondary cell separator coating material, since the saponification degree of the polyvinyl alcohol is the predetermined value or more, the wettability can be improved. As a result, it is possible to form the uniform coating film, and the heat resistance and the adhesion are improved.

The secondary cell separator coating material includes the above-described ingredient for a secondary cell separator coating material. Therefore, the heat resistance and the adhesion are excellent.

The secondary cell separator includes the coating film of the above-described secondary cell separator coating material. Therefore, the heat resistance and the adhesion are excellent.

The secondary cell includes the above-described secondary cell separator. Therefore, the heat resistance and the adhesion are excellent.

### EXAMPLES

The specific numerical values in mixing ratio (content ratio), property value, and parameter used in the following description can be replaced with upper limit values (numerical values defined as “or less” or “below”) or lower limit values (numerical values defined as “or more” or “above”) of corresponding numerical values in mixing ratio (content ratio), property value, and parameter described in the above-described “DESCRIPTION OF EMBODIMENTS”. All designations of “part” or “parts” and “%” mean part or parts by mass and % by mass, respectively, unless otherwise particularly specified.

### <Details of Components>

Trade names and abbreviations of each of the components used in Examples and Comparative Examples are described in detail.
Main: methacrylamide
AM: acrylamide
Mac: methacrylic acid
HEMA: 2-hydroxyethyl methacrylate
St: styrene
BA: n-butyl acrylate
Kuraray Poval 60-98: unmodified polyvinyl alcohol, saponification degree of 98 mol % to 99 mol %, manufactured by KURARAY CO., LTD.
Kuraray Poval 28-98: unmodified polyvinyl alcohol, saponification degree of 98 mol % to 99 mol %, manufactured by KURARAY CO., LTD.
Kuraray Poval 5-98: unmodified polyvinyl alcohol, saponification degree of 98 mol % to 99 mol %, manufactured by KURARAY CO., LTD.
Kuraray Poval 44-88: unmodified polyvinyl alcohol, saponification degree of 87 mol % to 89 mol %, manufactured by KURARAY CO., LTD.
Kuraray Poval 40-80E: unmodified polyvinyl alcohol, saponification degree of 80 mol %, manufactured by KURARAY CO., LTD.
AF17: carboxyl-group modified polyvinyl alcohol, saponification degree of above 96 mol %, manufactured by JAPAN VAM&POVAL CO., LTD.
GOHSENOL CKS50: sulfo-group modified polyvinyl alcohol, saponification degree of 99 mol %, manufactured by Mitsubishi Chemical Corporation
EXCEVAL RS-2117: hydrophobic group-modified unmodified polyvinyl alcohol, saponification degree of 98 mol % to 99 mol %, manufactured by KURARAY CO., LTD.
EXCEVAL RS-1113: hydrophobic group-modified unmodified polyvinyl alcohol, saponification degree of 98 mol % to 99 mol %, manufactured by KURARAY CO., LTD.
OLFINE E1010: wetting agent (acetylenic surfactant), manufactured by Nissin Chemical co., ltd.
Ammonium polycarboxylate: dispersant, aqueous solution of ammonium polycarboxylate, trade name: SN5468, manufactured by SAN NOPCO LIMITED

### Production of Water-Soluble Acrylic Resin

### Production Example 1

A separable flask equipped with a stirrer and a reflux condenser was charged with 200.0 parts by mass of distilled water to be replaced with nitrogen gas, and then, the charged water was heated to 80° C. Next, 0.6 parts by mass of ammonium persulfate was added, and thereafter, the following water-soluble acrylic resin raw material was continuously added over three hours. Further, the raw material was held furthermore three hours to complete the polymerization. Ammonia water was added thereto, and the pH thereof was adjusted to 9.0, and furthermore, an appropriate amount of water was added, thereby obtaining the aqueous solution of the water-soluble polymer (solid content of 15.0% by mass).

{Water-Soluble Acrylic Resin Raw Material}

| | | |
|---|---|---|
| Methacrylamide | 80.0 | parts by mass |
| Methacrylic acid | 5.0 | parts by mass |
| 2-hydroxyethyl methacrylate | 15.0 | parts by mass |
| 25% ammonia water | 3.0 | parts by mass |
| Distilled water | 300.0 | parts by mass |

### Production Examples 2, 3, 5, and 6

The aqueous solution of the water-soluble polymer (solid content of 15.0% by mass) was obtained in the same manner as Production Example 1. However, formulations of the water-soluble acrylic resin raw material were changed in accordance with the descriptions of Table 1.

### Production of Acrylic Emulsion

### Production Example 4

The separable flask equipped with the stirrer was charged with 0.4 parts by mass of dodecylbenzene sulfonate as a surfactant and 300 parts by mass of water to be nitrogen-purged, while stirring, and the temperature thereof was increased to 70° C. Next, 1 part by mass of potassium persulfate as the polymerization initiator was added, thereafter, the following emulsified liquid was continuously added over three hours, and furthermore, the obtained mixture was further stirred at 80° C. for five hours to react. Thereafter, the obtained mixture was cooled and the pH thereof was adjusted to 9 with 25% ammonia water. Thereafter, the appropriate amount of water was added, thereby obtaining the aqueous dispersion liquid of acrylic resin particles (solid content concentration of 20% by mass). A particle diameter of the acrylic resin particles was 0.2 μm.

### {Preparation of Emulsified Liquid}

In the aqueous solution containing 170 parts by mass of water and 1.0 part by mass of dodecylbenzene sulfonate, 55 parts by mass of n-butyl acrylate, 30 parts by mass of styrene, 5 parts by mass of methacrylic acid, and 10 parts by mass of 2-hydroxylethylmethacrylate were continuously added, while stirring, thereby obtaining the emulsified liquid.

### <Preparation of Polyvinyl Alcohol>

The polyvinyl alcohol described in Tables 2 and 3 was prepared as follows. Specifically, the separable flask equipped with the stirrer was charged with 90 parts by mass of water, and 10 parts by mass of polyvinyl alcohol was gradually added thereto, while stirring, and the temperature of the mixture was increased to 95° C. and held for three hours. After confirming that the polyvinyl alcohol was completely dissolved, it was cooled and the appropriate amount of water was added, thereby preparing the aqueous solution of 10% polyvinyl alcohol.

### <Production of Ingredient for Secondary Cell Separator Coating Material, Secondary Cell Separator Coating Material, and Secondary Cell Separator>

### Examples 1 to 13 and Comparative Examples 1 to 3

### (Production of Ingredient for Secondary Cell Separator Coating Material)

The water-soluble acrylic resin and the polyvinyl alcohol were mixed in accordance with the formulations described in Tables 2 and 3. Thus, the ingredient for a secondary cell separator coating material was produced. In addition, in Comparative Example 2, an acrylic emulsion was used instead of the water-soluble acrylic resin. Numerical values described in Tables 2 and 3 are numerical values of the solid content.

### (Production of Secondary Cell Separator Coating Material)

The dispersant was added to 123 parts by mass of water in accordance with the formulations described in Tables 2 and 3. Next, as the inorganic particles, 100 parts by mass of boehmite (aluminum hydroxide oxide, manufactured by Nabaltec AG, trade name “APYRAL AOH60”, average median diameter D50: 0.9 μm) was gradually added, while stirring with a disper (1000 rpm). After the addition, it was further stirred with a homogenizer (5000 rpm). Thus, the aqueous dispersion liquid of the inorganic particles (solid content concentration of the inorganic particles of 45% by mass) was obtained.

Next, the ingredient for a secondary cell separator coating material was blended into the aqueous dispersion liquid of the inorganic particles, and the water was appropriately added and stirred.

Thereafter, the obtained mixture was filtered through a 300-mesh filter (filtered particle size of 48 μm). Thus, the secondary cell separator coating material (dispersion liquid of the secondary cell separator coating material) was produced. The solid content concentration of the dispersion liquid of the secondary cell separator coating material was 40% by mass.

### (Production of Secondary Cell Separator)

### [First Step]

As the porous film, a polyolefin porous film (without the surface treatment (corona treatment)) was prepared.

### [Second Step]

The above-described secondary cell separator coating material (dispersion liquid of the secondary cell separator coating material) was coated onto one surface of the polyolefin porous film using a wire bar. Thereafter, the obtained coated product was dried at 50° C. Thus, the coating film (thickness of 2 μm) of the secondary cell separator coating material was formed on one surface of the polyolefin porous film. Thus, the secondary cell separator was produced.

### <Evaluation>

### [Weight Average Molecular Weight]

As for each of the water-soluble acrylic resins or the acrylic emulsions of Production Examples, the weight average molecular weight was determined in terms of standard polyethylene glycol/polyethylene oxide based on the following conditions. The results are shown in Table 1.

### {Conditions}

Device: GPC equipment, equipment name: P KP-22, manufactured by FLOM corp.
Sample concentration: 0.1 (w/v) %
Sample injection volume: 100 μL
Eluent: 0.2 M NaNO₃/acrylonitrile (AN)=90/10
Flow rate: 1.0 ml/min
Measurement temperature: 40° C.
Column: ShodexohPAK SB-806M HQ×2

### [Glass Transition Temperature]

The glass transition temperature (Tg) of each of the water-soluble acrylic resins or the acrylic emulsions of Production Examples was calculated by the following FOX formula. The results are shown in Table 1.

$$1 / Tg = {W}_{1} / {Tg}_{1} + {W}_{2} / {Tg}_{2} + … + {W}_{n} / {Tg}_{n} \qquad ( 1 )$$

[In formula, Tg represents the glass transition temperature of the copolymer (unit: K), Tgi (i=1, 2, n) represents the glass transition temperature (unit: K) when the monomer i forms a homopolymer, and Wᵢ (i=1, 2, n) represents a mass fraction in the total monomer of the monomer i.]

### [Heat Resistance]

Each of the secondary cell separators of Examples and Comparative Examples was cut into pieces having a size of 5 cm×5 cm to be used as test pieces. The test pieces were left to stand in an oven at 150° C. for one hour. The length of each side of the test pieces was measured before and after being left. A shrinkage rate was calculated from the length of each side before and after the shrinkage based on the following formula (2). The results are shown in Tables 2 and 3.

$$Shrinkage rate ( \% ) = \{ average length of one side before shrinkage ( cm ) - average length of one side after shrinkage ( cm ) \} / average length of one side before shrinkage ( cm ) \times 100 \qquad ( 2 )$$

### [Ion Permeability]

Air permeability resistance of each of the secondary cell separators of Examples and Comparative Examples was obtained by measurement in conformity with JIS-P-8117 with an Oken-type air permeability-smoothness tester manufactured by ASAHI SEIKO CO., LTD. An amount of decrease in the air permeability with respect to the air permeability of the porous film itself was referred to as Δ air permeability. Specifically, Δ air permeability was calculated based on the following formula (3). It was evaluated that the smaller the Δ air permeability was, the more excellent the ion permeability was. The results are shown in Tables 2 and 3.

Δair permeability=measured air permeability−180(air permeability of porous film itself) (3)

### [Adhesion]

The coating film in each of the secondary cell separators of Examples and Comparative Examples was rubbed with an eraser, and peeling of the coating film was evaluated based on the following criteria. The results are shown in Tables 2 and 3.
1 point: when rubbed with 100-g weight once, the coating film was peeled.
2 points: when rubbed with 100-g weight 2 to 3 times, the coating film was peeled.
3 points: when rubbed with 100-g weight 4 to 5 times, the coating film was peeled.
4 points: even when rubbed with 100-g weight 5 times, the coating film was not peeled, and when rubbed with 400-g weight 5 times, the coating film was peeled.
5 points: even when rubbed with 100-g weight 5 times, the coating film was not peeled, and even when rubbed with 400-g weight 5 times, the coating film was not peeled.

### CONSIDERATION

It was found that Examples 1 to 13 including the water-soluble acrylic resin, and the polyvinyl alcohol having the saponification degree of the predetermined value or more have the more excellent heat resistance and the more excellent adhesion than Comparative Example 1 containing no polyvinyl alcohol, Comparative Example 2 containing no water-soluble acrylic resin and containing the acrylic emulsion, and Comparative Example 3 containing the polyvinyl alcohol having the saponification degree of below the predetermined value.

TABLE 1

| Production Ex. 1 | | Mam | AM | Mac | HEMA | St | BA | Tg | Mw |
|---|---|---|---|---|---|---|---|---|---|
| Water-Soluble | Production Ex. 1 | 80 | — | 5 | 15 | — | — | 221 | 70,000 |
| Acrylic Resin | Production Ex. 2 | 95 | — | 5 | — | — | — | 263 | 65,000 |
| | Production Ex. 3 | 80 | — | 10 | 10 | — | — | 232 | 110,000 |
| | Production Ex. 5 | — | 70 | 5 | 25 | — | — | 125 | 200,000 |
| | Production Ex. 6 | — | 70 | 30 | — | — | — | 162 | 450,000 |
| Acrylic Emulsion | Production Ex. 4 | — | — | 5 | 10 | 30 | 55 | −6 | Unmeasurable |

TABLE 2

| Ex. No. | | | | | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|---|---|---|---|
| Secondary | Ingredient | Water-Soluble Acrylic | | Production Ex. 1 | 4 | — | — | — | — | 4 | 4 | 4 | 4 |
| Cell | for | Resin | | Production Ex. 2 | -— | 4 | — | — | — | — | — | — | — |
| Separator | Secondary | | | Production Ex. 3 | — | — | 4 | — | — | — | — | — | — |
| Coating | Cell | | | Production Ex. 5 | — | — | — | 4 | — | — | — | — | — |
| Material | Separator | | | Production Ex. 6 | — | — | — | — | 4 | — | — | — | — |
| | Coating | Acrylic Emulsion | | Production Ex. 4 | — | — | — | — | — | — | — | — | — |
| | Material | Polyvinyl | Unmodified | Kuraray Poval 60-98 | — | — | 0.6 | 0.6 | 0.6 | — | — | 0.2 | 2.0 |
| | | Alcohol | Polyvinyl | Kuraray Poval 28-98 | — | — | — | — | — | 0.6 | — | — | — |
| | | | Alcohol | Kuraray Poval 5-98 | — | — | — | — | — | — | 0.6 | — | — |
| | | | | Kuraray Poval 44-88 | — | — | — | — | — | — | — | — | — |
| | | | | Kuraray Poval 40-80E | — | — | — | — | — | — | — | — | — |
| | | | Carboxyl | AF17 | 0.6 | — | — | — | — | — | — | — | — |
| | | | Group- | | | | | | | | | | |
| | | | Modified | | | | | | | | | | |
| | | | Polyvinyl | | | | | | | | | | |
| | | | Alcohol | | | | | | | | | | |
| | | | Sulfo Group- | GOHSENOL CKS50 | — | 0.6 | — | — | — | — | — | — | — |
| | | | Modified | | | | | | | | | | |
| | | | Polyvinyl | | | | | | | | | | |
| | | | Alcohol | | | | | | | | | | |
| | | | Hydrophobic | EXCEVAL RS-2117 | — | — | — | — | — | — | — | — | — |
| | | | Group- | EXCEVAL RS-1113 | — | — | — | — | — | — | — | — | — |
| | | | Modified | | | | | | | | | | |
| | | | Polyvinyl | | | | | | | | | | |
| | | | Alcohol | | | | | | | | | | |

| | | | | | | | | | | |
|---|---|---|---|---|---|---|---|---|---|---|
| Wetting Agent | OLFINE E1010 | — | — | — | — | — | — | — | — | — |

| | Saponification Degree of Polyvinyl Alcohol (mol %) | | Above 96 | 99 | 98-99 | 98-99 | 98-99 | 98-99 | 98-99 | 98-99 | 98-99 |
|---|---|---|---|---|---|---|---|---|---|---|---|
| | Content Ratio of Polyvinyl Alcohol to 100 Parts | | 15 | 15 | 15 | 15 | 15 | 15 | 15 | 5 | 50 |
| | by Mass of Water-Soluble Acrylic Resin | | | | | | | | | | |
| | Inorganic Particles | Aluminum | 100 | 100 | 100 | 100 | 100 | 100 | 100 | 100 | 100 |
| | | Hydroxide | | | | | | | | | |
| | | Oxide | | | | | | | | | |
| | Dispersant | Anmonium | 1 | 1 | 1 | 1 | 1 | 1 | 1 | 1 | 1 |
| | | Polycarboxylate | | | | | | | | | |
| Evaluation | Heat Resistance | Shrinkage Rate (%) | 50 | 57 | 48 | 80 | 80 | 55 | 58 | 51 | 31 |
| | Ion Permeability | Δ Air Permeability | 35 | 20 | 35 | 260 | 280 | 45 | 40 | 28 | 60 |

| | | | | | | | | | |
|---|---|---|---|---|---|---|---|---|---|
| Adhesion | 5 | 4 | 5 | 4 | 3 | 4 | 4 | 3 | 3 |

TABLE 3

| Ex. Comparative Ex. No. | | | | | Ex. 10 | Ex. 11 | Ex. 12 | Ex. 13 |
|---|---|---|---|---|---|---|---|---|
| Secondary | Ingredient | Water-Soluble Acrylic | | Production Ex. 1 | 4 | 4 | 4 | 4 |
| Cell | for | Resin | | Production Ex. 2 | — | — | — | — |
| Separator | Secondary | | | Production Ex. 3 | — | — | — | — |
| Coating | Cell | Acrylic Emulsion | | Production Ex. 4 | — | — | — | — |
| Material | Separator | Polyvinyl | Unmodified | Kuraray Poval 60-98 | — | — | — | 3.0 |
| | Coating | Alcohol | Polyvinyl | Kuraray Poval 28-98 | — | — | — | — |
| | Material | | Alcohol | Kuraray Poval 5-98 | — | — | — | — |
| | | | | Kuraray Poval 44-88 | 0.6 | — | — | — |
| | | | | Kuraray Poval 40-80E | — | — | — | — |
| | | | Carboxyl | AF17 | — | — | — | — |
| | | | Group- | | | | | |
| | | | Modified | | | | | |
| | | | Polyvinyl | | | | | |
| | | | Alcohol | | | | | |
| | | | Sulfo Group- | GOHSENOL CKS50 | — | — | — | — |
| | | | Modified | | | | | |
| | | | Polyvinyl | | | | | |
| | | | Alcohol | | | | | |
| | | | Hydrophobic | EXCEVAL RS-2117 | — | 0.6 | — | — |
| | | | Group- | EXCEVAL RS-1113 | — | — | 0.6 | — |
| | | | Modified | | | | | |
| | | | Polyvinyl | | | | | |
| | | | Alcohol | | | | | |

| | | | | | |
|---|---|---|---|---|---|
| Wetting Agent | OLFINE E1010 | — | — | — | — |

| | Saponification Degree of Polyvinyl Alcohol (mol %) | | 88 | 98-99 | 98-99 | 98-99 |
|---|---|---|---|---|---|---|
| | Content Ratio of Polyvinyl Alcohol to 100 Parts | | 15 | 15 | 15 | 75 |
| | by Mass of Water-Soluble Acrylic Resin | | | | | |
| | Inorganic Particles | Aluminum | 100 | 100 | 100 | 100 |
| | | Hydroxide | | | | |
| | | Oxide | | | | |
| | Dispersant | Anmonium | 1 | 1 | 1 | 1 |
| | | Polycarboxylate | | | | |
| Evaluation | Heat Resistance | Shrinkage Rate (%) | 60 | 70 | 75 | 30 |
| | Ion Permeability | Δ Air Permeability | | | | |

| | | | | |
|---|---|---|---|---|
| Adhension | 4 | 5 | 4 | 5 |

| | | | | | | Compara- | Compara- |
|---|---|---|---|---|---|---|---|
| | | | | | Comparative | tive | tive |
| | | | | | Ex. 1 | Ex. 2 | Ex. 3 |
| Secondary | Ingredient | Water-Soluble Acrylic | | Production Ex. 1 | 4 | — | 4 |
| Cell | for | Resin | | Production Ex. 2 | — | — | — |
| Separator | Secondary | | | Production Ex. 3 | — | — | — |
| Coating | Cell | Acrylic Emulsion | | Production Ex. 4 | — | 4 | — |
| Material | Separator | Polyvinyl | Unmodified | Kuraray Poval 60-98 | — | 0.6 | — |
| | Coating | Alcohol | Polyvinyl | Kuraray Poval 28-98 | — | — | — |
| | Material | | Alcohol | Kuraray Poval 5-98 | — | — | — |
| | | | | Kuraray Poval 44-88 | — | — | — |
| | | | | Kuraray Poval 40-80E | — | — | 0.6 |
| | | | Carboxyl | AF17 | — | — | — |
| | | | Group- | | | | |
| | | | Modified | | | | |
| | | | Polyvinyl | | | | |
| | | | Alcohol | | | | |
| | | | Sulfo Group- | GOHSENOL CKS50 | — | — | — |
| | | | Modified | | | | |
| | | | Polyvinyl | | | | |
| | | | Alcohol | | | | |
| | | | Hydrophobic | EXCEVAL RS-2117 | — | — | — |
| | | | Group- | EXCEVAL RS-1113 | — | — | — |
| | | | Modified | | | | |
| | | | Polyvinyl | | | | |
| | | | Alcohol | | | | |

| | | | | |
|---|---|---|---|---|
| Wetting Agent | OLFINE E1010 | 0.6 | — | — |

| | Saponification Degree of Polyvinyl Alcohol (mol %) | | — | 98-99 | 80 |
|---|---|---|---|---|---|
| | Content Ratio of Polyvinyl Alcohol to 100 Parts | | 15 | 15 | 15 |
| | by Mass of Water-Soluble Acrylic Resin | | | | |
| | Inorganic Particles | Aluminum | 100 | 100 | 100 |
| | | Hydroxide | | | |
| | | Oxide | | | |
| | Dispersant | Anmonium | 1 | 1 | 1 |
| | | Polycarboxylate | | | |
| Evaluation | Heat Resistance | Shrinkage Rate (%) | 80 | 80 | 76 |
| | Ion Permeability | Δ Air Permeability | 40 | 10 | 60 |

| | | | |
|---|---|---|---|
| Adhension | 2 | 1 | 2 |

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### INDUSTRIAL APPLICATION

The ingredient for a secondary cell separator coating material, the secondary cell separator coating material, and the secondary cell separator of the present invention are preferably used in production of a secondary cell.

1. An ingredient for a secondary cell separator coating material comprising:
a water-soluble acrylic resin and polyvinyl alcohol, wherein
a saponification degree of the polyvinyl alcohol is 85 mol % or more.

2. The ingredient for a secondary cell separator coating material according to claim 1, wherein
a content ratio of the polyvinyl alcohol is 5 parts by mass or more and 50 parts by mass or less with respect to 100 parts by mass of the water-soluble acrylic resin.

3. The ingredient for a secondary cell separator coating material according to claim 1, wherein
the polyvinyl alcohol is at least one selected from the group consisting of unmodified polyvinyl alcohol and anionic group-modified polyvinyl alcohol.

4. The ingredient for a secondary cell separator coating material according to claim 1, wherein
a weight average molecular weight of the water-soluble acrylic resin is 10000 or more and 150000 or less.

5. A secondary cell separator coating material comprising:
the ingredient for a secondary cell separator coating material according to claim 1 and inorganic particles.

6. A secondary cell separator comprising:
a porous film and
a coating film of the secondary cell separator coating material according to claim 5 disposed on at least one surface of the porous film.

7. A secondary cell comprising:
a positive electrode, a negative electrode, and the secondary cell separator according to claim 6 disposed between the positive electrode and the negative electrode.
